(19) United States
(12) Patent Application Publication
(10) Pub. No.: US 2012/0213380 A1
(43) Pub. Date: Aug. 23, 2012

(54) Method and Device for Cancelling Acoustic Echo by Audio Watermarking

(75) Inventors: Gaël Mahé, Versailles (FR); Imen Mezghani-Marrakchi, Sfax (TN); Meriem Jaidane, Tunis (TN); Monia Turki, Sidi Daoud (TN); Sonia Larbl Djaziri, Tunis (TN)

(73) Assignee: UNIVERSITE PARIS DESCARTES, Paris (FR)

(21) Appl. No.: 13/503,607

(22) PCT Filed: Oct. 27, 2010
(86) PCT No.: PCT/FR2010/052309

§ 371 Date: Apr. 23, 2012

(30) Foreign Application Priority Data
Oct. 29, 2009 (FR) 09 57636

(51) Int. Cl. G10K 11/16

(52) U.S. Cl. 381/71.11; 381/71.8

(57) ABSTRACT

A method of cancelling acoustic echo in a first signal comprising an echo signal of a second signal, comprising: inserting, in an inaudible manner, into the second signal a pseudo-random sequence whose circular autocorrelation comprises a unit impulse and a continuous component; characterizing, in the first signal, by means of the inserted sequence, an acoustic channel followed by the echo signal; estimating the echo signal in the first signal by means of the characterization of the acoustic channel; and cancelling the echo signal by means of the obtained estimation.

### TECHNICAL FIELD

The present invention relates to audio signal processing.

More particularly, it concerns the cancellation of acoustic echo in sound pickup and reproduction systems, particularly those used In communication systems.

### TECHNOLOGICAL BACKGROUND

In “hands-free” sound pick-up and reproduction systems (for example videoconferencing devices), a first terminal transmits a voice signal to a second terminal. A speaker of the second terminal then emits the signal. The emitted signal follows one or more echo paths. A microphone of the second terminal then picks up a sound signal comprising the echo of the emitted signal (and corresponding to the transmitted signal).

Echo is reduced by an acoustic echo cancellation system (AEC). In these systems, the acoustic channel between the reproduction system and the sound pick-up system, comprising one or more echo paths, is determined by estimating the impulse response of this acoustic channel. The estimation of the acoustic channel impulse response is usually done in real time and in an adaptive manner at the second terminal. The digital filter, used for the adaptation is controlled by the voice signal transmitted by the first terminal.

The performance of such systems is degraded by several factors, such as:
the statistical features of the audio signal (for example its high correlation and its non-stationary nature), and
the context of double talking, in the case where the second terminal picks up a near-end voice signal which is added to the echo and the ambient noise. Indeed, the presence of a near-end speech added t o the ambient noise interferes with the convergence of the AEC.

In existing acoustic echo cancellation systems, which are based on adaptive methods, the problem of the existence of a near-end speech arises due to the fact that the adaptive filter can no longer follow the variations of the acoustic channel and therefore follows those of the near-end speech. In this case, the algorithm converges to an incorrect solution.

To solve this problem, the prior art proposes stopping the adaptation when double talking is present. However, this solution prevents a correct estimation of the echo.

A prior art echo cancellation system (AEC) used in a sound communication system (for example a telephone in hands-free mode) Is now described with reference to FIG. 1.

A first party sends, from a first terminal, a signal x(n) which is then output from the speaker SP of a second terminal. The signal emitted by the speaker is then reflected by the environment (the walls for example) where the speaker is located. The reflection, as well as the direct echo caused by the direct passage of sound between the speaker and the microphone MIC of the second terminal, result in an echo signal z(n).

The echo signal, an ambient noise signal n(n), and the speech of a second party s(n) are picked up by the microphone MIC provided for picking up the speech of the second party, and are then transmitted to the terminal.

The signal received by the first speaker is then a mixture of the speech of the second party and the speech of the first party x(n) filtered by the acoustic channel f between the speaker and the microphone (z(n)=f*x(n), where * Indicates the convolution).

The signal picked up by the microphone is then: y(n)=z(n)+b(n)=(f *x(n))+b(n), where x(n) and f are respectively the signal received by the receiving speaker and the impulse response of the coupling, assumed to be linear, between the speaker and the microphone, and b(n)=n(n)+s(n) is a combination of the ambient noise n(n) and the near-end speech s(n).

An echo cancellation system is placed between the lines transmitting the signals x(n) and y(n), for example at the second terminal.

This echo cancellation system is responsible for estimating and simulating the acoustic channel f using a FIR filter h, so as to subtract from the b(n)+f*x(n) combination an estimation of f*x(n), given by h(n)*x(n).

As the acoustic propagation channel varies over time, adaptive algorithms are used.

Their role is at first to “learn” and then to continuously update the coefficients of the FIR filter h(n) to maintain good echo compensation in spite of these variations.

However, these adaptive algorithms suffer from robustness issues due to the variations over time of the statistical properties of the emitted sound signal x(n) driving the AEC (correlation, non-stationarity, etc.).

The coefficients of the filter h(n)=[h₀(n), h₁(n) . . . h_{P-1}(n)]^{T} are, for example, adapted using a normalized algorithm of the NLMS type (Normalized Least Mean Square).

This algorithm minimizes the mean square error between the output from the filter h(n) and the echo. The adaptation of h(n) is then done as follows:

$$h ( n + 1 ) = h ( n ) + μ e ( n ) \frac{X ( n )}{{X ( n )}^{T} X ( n ) + ɛ}$$

where μ is an adaptation pitch that is generally fixed, e(n) is the estimation error which controls the adaptation of the filter h(n) and X(n)=[x(n),x(n−1), . . . , x(n-P+1)]^{T} is the input vector of length P, and ε is a low strictly positive value to avoid a zero denominator for the fraction during periods of silence.

It has been proposed to insert additive watermarking into the incident signal x(n) in order to modify the statistical properties of the signal (S. Larbi and M. Jaïdane, “Audio watermarking: a way to modify audio statistics”, IEEE Trans. on Signal Processing, vol. 53(2), 2005).

However, this method has at least two disadvantages:
the AEC insufficiently attenuates the echo and remains sensitive to the statistics of the watermarked speech signal, and
the double talking issue is not resolved.

The inventors have also proposed an echo cancellation system called WAEC (Marrakchi and al., “Speech processing in the watermarked domain: application in adaptive acoustic echo cancellation”, European Signal Processing Conference, Italy, 2006), based on audio watermarking the source speech signal to embed white noise in order to estimate the acoustic channel by a signal having better properties than the source speech signal.

In this system, two adaptive filters operate in parallel.

The clear superiority of WAEC over conventional AEC is due to the fact that the signals involved in the operation of the WAEC are almost uncorrelated and are much more stationary. With this system, the inventors obtained a significant gain in the echo attenuation.

However, this structure can be further improved, particularly when double talking is present.

### SUMMARY OF THE INVENTION

A need therefore exists for an acoustic echo cancellation system offering a satisfactory quality of echo cancellation while having little sensitivity to the characteristics of the voice signal and to the existence of double talking.

The present invention improves this situation.

To this end, a first aspect of the invention proposes a method of cancelling acoustic echo in a first signal comprising an echo signal of a second signal. The method comprises:
inserting into the second signal, in an inaudible manner, a pseudo-random sequence whose circular autocorrelation comprises a unit impulse and a continuous component,

characterizing, in the first signal, by means of the inserted sequence, an acoustic channel followed by the echo signal,

estimating the echo signal in the first signal by means of the characterization of the acoustic channel, and

cancelling the echo signal by means of the obtained estimation.

The inserted pseudo-random sequence is independent of the near-end speech signal, which improves the characterization (or identification) of the echo channel (or path).

Thus, the quality of the characterization is constant and has little dependency on statistical variations in the signals used in the echo cancellation.

With the method of the invention, the quality of the characterization is improved, even in a double talking context.

The present invention provides satisfactory quality in telephone calls or videoconferencing, even when statistical variations in the emitted speech and the near-end speech are present.

In addition, with the method of the invention, the echo cancellation is faster and more precise than in the prior art.

For example, the characterization of the acoustic channel (or echo path) is done by intercorrelation of the first signal with the pseudo-random sequence.

This minimizes the effect of the existence of near-end speech during identification because of the statistical independence of the pseudo-random sequence and the near-end speech.

As a further example, the characterization of the acoustic channel comprises adaptive filtering of the second signal.

The characterization may also comprise a block-based filtering of the second signal.

The use of the pseudo-random sequence reduces the disruption of the signal in the presence of double talking.

In some embodiments, the characterization of the acoustic channel comprises the steps of:
performing an adaptive and/or block-based filtering of the second signal, and
performing an intercorrelation of the first signal with the pseudo-random sequence.

The filtering eliminates the influence of the second signal before the intercorrelation, thus increasing the quality of this intercorrelation. For example, it is possible to decrease the power of the second signal relative to the power of the pseudo-random sequence.

In some embodiments, the method additionally comprises:
applying a shaping filter to the pseudo-random sequence before it is embedded in the second signal.

For example, the shaping filter is used to ensure the inaudibility of the pseudo-random sequence, based on psychoacoustic models.

In this case, the filter can be designed to yield an inaudible sequence with maximum power to optimize its use in echo cancellation.

In some embodiments, there can also be a step of processing the first signal before the correlation with the pseudo-random sequence. This processing may comprise the subtracting of the result of the filtering of the second signal from the first signal. This can improve the quality of the result of the correlation.

For example, the processing may also comprise the application of a filter to cancel the effects of the shaping filter on the pseudo-random sequence.

Other aspects of the invention relate to:
a computer program comprising instructions for implementing the method of the invention when the program is executed by a processor, for example the processor of an echo cancellation system;
a computer-readable medium on which such a computer program is stored;
a circuit configured to implement the method of the invention; and
an echo cancellation system adapted to implement the method of the invention.

The advantages provided by the computer program, the computer-readable medium, the circuit, and the system, as briefly described above, are at least identical to those mentioned above in relation to the echo cancellation method of the invention.

### BRIEF DESCRIPTION OF THE DRAWINGS

Other features and advantages of the invention will be further apparent from reading the following description. This is purely Illustrative and is to be read in relation to the attached drawings, in which, in addition to FIG. 1:

FIG. 2 is a block diagram illustrating a method according to a first embodiment of the invention;

FIG. 3 is a block diagram illustrating a method according to a second embodiment of the invention;

FIG. 4 is a general flowchart of the method according to some embodiments of the invention;

FIG. 5 illustrates an echo cancellation system according to an embodiment of the invention; and

FIGS. 6 to 9 illustrate some test results showing some of the advantages provided by the invention.

### DETAILED DESCRIPTION OF THE EMBODIMENTS

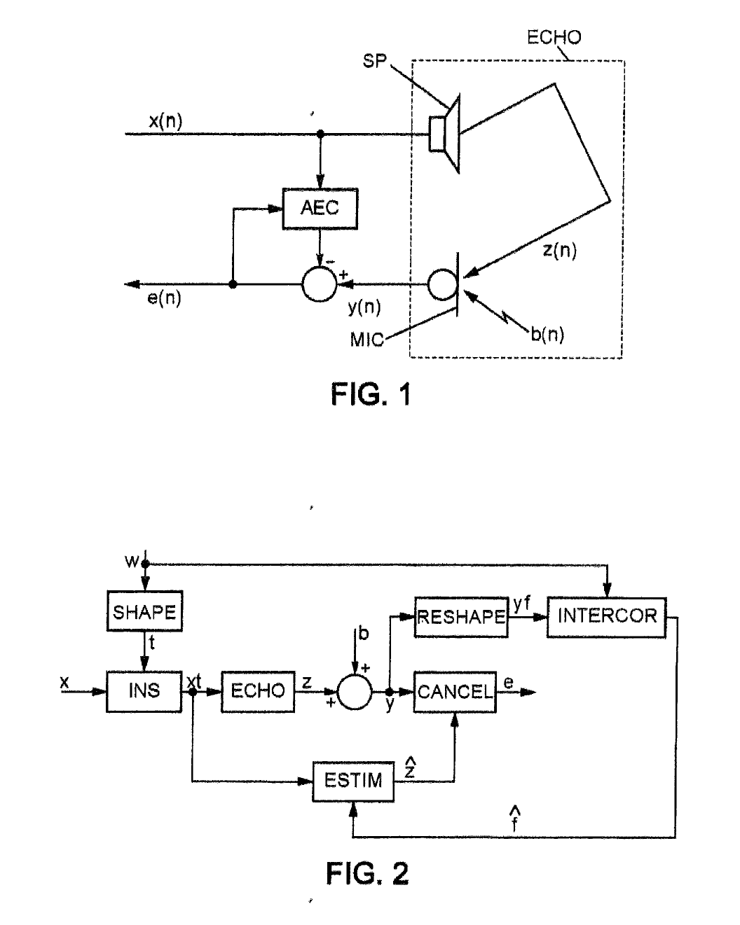

The implementation of a method according to a first embodiment is now schematically described with reference to FIG. 2.

In this embodiment, the echo cancellation occurs by the embedding of a digital sequence (a method also called digital watermarking), then by intercorrelation of the embedded sequence with the signal containing the echo signal to perform the characterization (or identification) of the acoustic channel (or echo path). The final cancellation of the echo occurs by subtracting, from the signal containing the echo, an estimation of the echo based on the identification of the acoustic channel.

The involved steps will first be described in general. Then, each of the steps will be detailed.

This embodiment, for example, is part of a communication between a first communication terminal such as a mobile telephone, and a second terminal in hands-free mode.

The echo to be processed arises at the second terminal, and is processed at this second terminal.

Other embodiments can be considered, in which the echo is processed at the first terminal, or in which the echo is processed in a telecommunications network.

The voice signal x initially emitted by a user of the first terminal is supplied to an insertion unit INS, for inserting a digital sequence which will be described in more detail below.

The inserted signal t comes from an initial signal w shaped by a shaping unit SHAPE. This shaping adapts the spectrum of the signal w to make it Inaudible once it is inserted in the signal x.

The signal xt obtained as output from the INS unit is then transmitted and undergoes a set of transformations modeled by the ECHO unit. These transformations correspond for example to its transmission and reflection.

A signal z is obtained as output from the ECHO unit, as described above with reference to FIG. 1.

A noise signal b is also added to this signal z, to shape the signal y. The signal y contains the echo of the signal x.

The signal y is then provided to a signal shaping unit RESHAPE which applies a transformation to the signal that is the inverse of the one performed by the SHAPE unit.

A signal yf is obtained as output from the RESHAPE unit which is then provided to an intercorrelation unit INTERCOR to perform the intercorrelation of the signal yf with the signal w.

The INTERCOR unit then provides a characterization \hat{f} of the acoustic channel represented by the ECHO unit. This characterization Is then provided to an ESTIM unit which also receives the signal xt as input, in order to output an estimate of the signal z.

The signal y and the estimate of the signal z are then provided to a CANCEL unit to subtract the echo from the signal y.

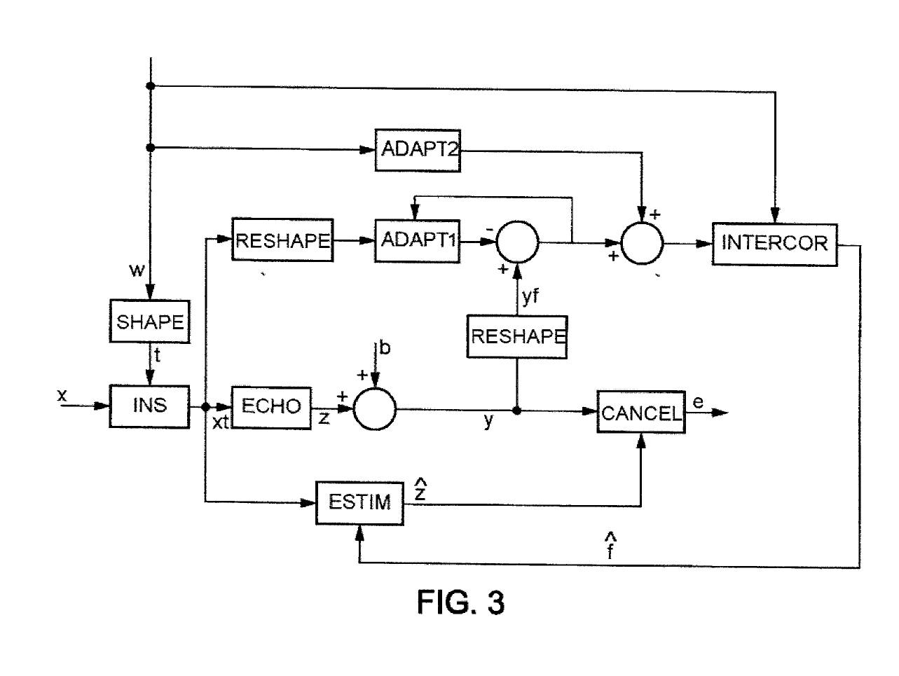

In a second embodiment, described with reference to FIG. 3, adaptive filtering is applied to the watermarked signal for performing a first identification of the acoustic channel, before the intercorrelation.

In this embodiment, we again have the units SHAPE, INS, ECHO, CANCEL, INTERCOR, and ESTIM of the first embodiment.

In addition, there is a second RESHAPE unit that is identical to the first one, and is supplied by the signal xt. The output from this second RESHAPE unit is coupled to the input of an adaptive filtering unit ADAPT1.

The signal w is also provided to a second ADAPT2 unit, which is a copy of the first ADAPT1 unit.

In this second embodiment, the output from the first RESHAPE unit is provided to a subtraction unit for performing the subtraction between the signal yf and the output from the first ADAPT1 unit. The result of this subtraction is delivered to the ADAPT1 unit to drive the filtering.

The output from the second ADAPT2 unit is then added to the output from the subtraction unit, and the sum is provided to the INTERCOR unit.

In a variant of the second embodiment (not represented), a block-based filtering is used instead of or in combination with the adaptive filtering. For example, a Wiener filter is implemented.

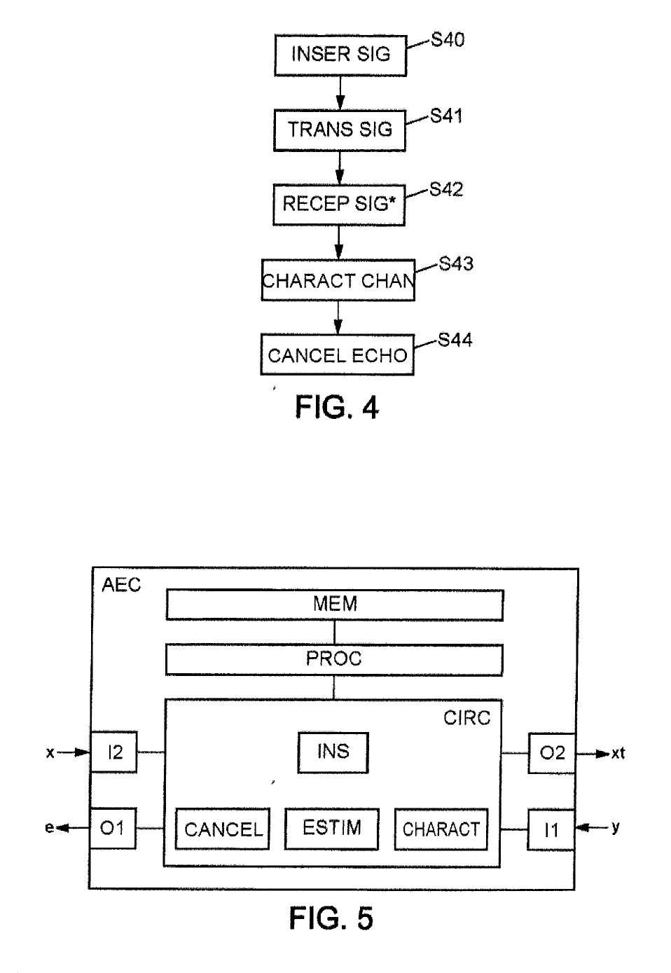

The steps of the method according to the described embodiments are summarized in the general flowchart of FIG. 4.

In a first step S40, the signal transmitted by the user of the first terminal is received by the second terminal and is then watermarked by the AEC by insertion of the digital sequence. Then, the watermarked signal is emitted by the speaker of the second terminal during step S41.

During step S42, the microphone of the second terminal receives a signal containing an echo signal of the previously transmitted signal.

Then, during step S43, a characterization of the acoustic channel is performed using the sequence inserted during the watermarking.

Lastly, during step S44, the echo is cancelled in the signal received by the microphone, using the obtained characterization.

A computer program comprising instructions for implementing the method of the invention can be executed according to a general algorithm deduced from the general flowchart of FIG. 4, and from the present detailed description.

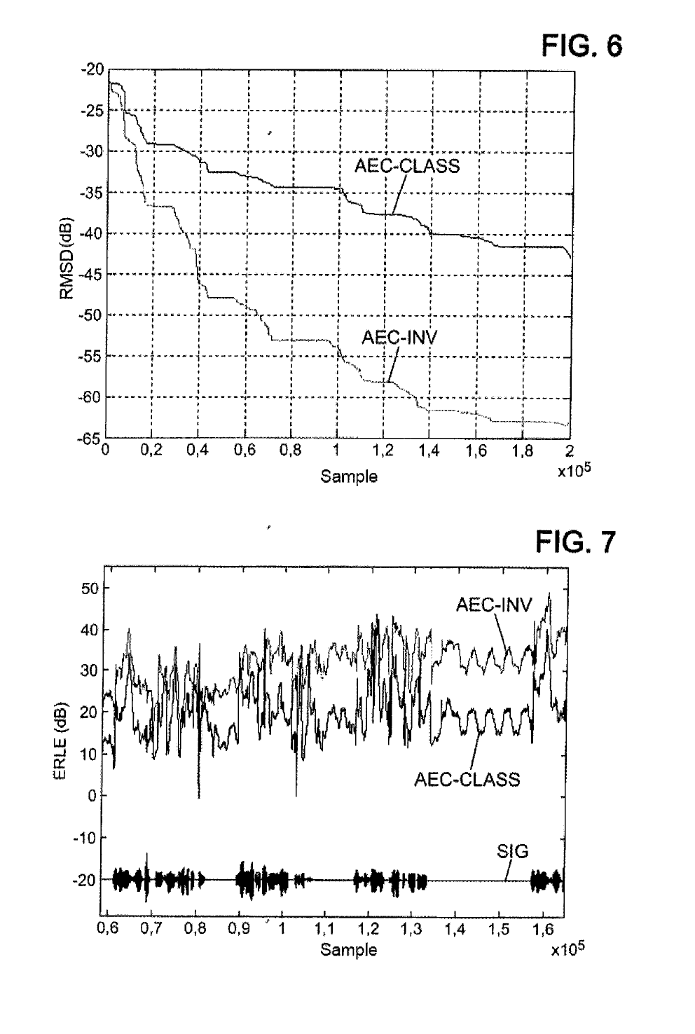

An echo cancellation system according to an embodiment of the invention is now described with reference to FIG. 5.

This echo cancellation system AEC comprises an input I2 for receiving a signal to be retransmitted, and an output O2 for retransmitting the received and watermarked signal. It also comprises an input I1 for receiving a signal containing an echo of the transmitted signal, and an output O1 for sending the signal with the cancelled echo.

The AEC system also comprises a memory MEM for storing calculation data. In some embodiments, the memory MEM can also store a computer program according to the present invention.

The system also comprises a processor PROC for controlling an echo cancellation circuit. For example, the processor executes a computer program stored in the memory MEM.

The circuit CIRC comprises a digital sequence insertion unit INS, an acoustic channel characterization unit CHARACT, an echo signal estimation unit ESTIM, and an echo cancellation unit CANCEL.

All these elements are arranged to operate according to the echo cancellation method of the invention.

The echo cancellation system may be part of a communication terminal. For example, it may be part of a communication terminal allowing communication in hands-free mode. Thus, the echo arising at this terminal can be directly canceled before the picked up voice signal is retransmitted. As a further example, the system may be part of a communication terminal which does not provide communication in hands-free mode, but which is in communication with a terminal allowing such communication. Thus, the terminal can eliminate the echo in a received signal.

As a further example, the echo cancellation system is implemented in a communication server. A telecommunications network operator making use of the server can then provide its subscribers with an echo cancellation service.

A system of the invention can be integrated into a terminal or a server, as briefly described, according to techniques known to a person skilled in the art.

The various operations mentioned above are now described in more detail: digital watermarking, characterization of the acoustic channel, echo cancellation, and adaptive or block-based filtering.

Finally, the results of tests conducted to show some of the advantages provided by the present invention are presented.

Digital Watermarking

The embedded signal w(n) is a periodized pseudo-random sequence of +1 and −1 of length L, called maximum length sequence (MLS). Its main property is to provide an L-periodized unit impulse plus a continuous component 1/L when its circular autocorrelation is performed:

$${ϕ}_{ww} ( n ) = \{ \begin{matrix}1 & if n = 0 mod L \\ - \frac{1}{L} & if n \neq 0\end{matrix}$$

where the circular autocorrelation is defined by:

$${φ}_{ww} ( n ) = \frac{1}{L} {\sum }_{k = 0}^{L - 1} w ( k ) w ( ( n + k ) mod L ) .$$

The temporal insertion of the watermarking signal in the audio signals is done inaudibly using psychoacoustic models.

In the case of speech, the masking threshold is approached by the Power Spectral Density (PSD) of the signal over a 20 ms frame, attenuated by a factor λ<1. As speech can be modeled by the filtering of white noise of variance σₑₓ² by an all-pole filter of transfer function 1/A(z), an inaudible watermarking obtained by the filtering of white noise w(n) by the filter of transfer function

$$G ( z ) = \frac{λ {σ}_{ex}}{A ( z )}$$

can be added. This filter is updated every L samples.

Channel Characterization by Intercorrelation

This involves exciting the channel by a periodized MLS sequence w(n) of length L. The signal y(n) output from the channel is:

$$y ( n ) = f * w ( n ) = {\sum }_{j = 0}^{P - 1} f ( j ) w ( n - j )$$

where P is the length of the impulse response f to be estimated.

The correlation between the output y(n) and the input w(n) is:

$$\begin{matrix}\begin{matrix}{φ}_{wy} ( n ) = \frac{1}{L} {\sum }_{k = 0}^{L - 1} w ( k ) y ( n + k ) \\ = \frac{1}{L} {\sum }_{k = 0}^{L - 1} {\sum }_{j = 0}^{P - 1} f ( j ) w ( k ) w ( n + k - j ) \\ = {\sum }_{j = 0}^{P - 1} f ( j ) {φ}_{ww} ( n - j )\end{matrix} & \\ Or \text{:} & \\ {φ}_{wy} ( n ) = \hat{f} ( n ) = f ( n ) + {P}_{1} ( n ) + {P}_{2} ( n ) \\ where \\ {P}_{1} ( n ) = {\sum }_{j = 1}^{[ P / L ]} f ( n + jL ) & \end{matrix}$$

is the disturbance due to the effect of sub-modeling when L<P.

$${P}_{2} ( n ) = - \frac{1}{L} {\sum }_{j = 1 , j \neq n + kL}^{P - 1} f ( j )$$

is the disturbance due to the “false unit impulse” effect.

The ideal situation occurs in the case of exact modeling (P<L) where P₁(n)=0 and for a sufficiently large L, and in this case P₂(n)≈0.

Echo Cancellation

The obtained watermarking signal is temporally added to the voice signal as illustrated by FIG. 2. The obtained watermarked signal xt(n) is then transmitted to the acoustic channel f to be identified. The obtained echo is given by:

$$\begin{matrix}y ( n ) = f * xt ( n ) + b ( n ) \\ = f * x ( n ) + f * t ( n ) + b ( n ) \\ = f * x ( n ) + f * g * w ( n ) + b ( n )\end{matrix}$$

By applying the inverse of the shaping filter g of the SHAPE unit to the echo signal, one obtains:

$$\begin{matrix}yf ( n ) = {g}^{- 1} * y ( n ) \\ = f * w ( n ) + f * xf ( n ) + bf ( n )\end{matrix}$$

where xf(n) and bf(n) are respectively the signals x(n) and b(n) filtered by the filter g⁻¹.

The channel estimation occurs by calculating the intercorrelation per block of L samples between the filtered echo signal and the original MLS sequence w(n):

φ_{wyf}(n)=f(n)+f*φ_{wxf}(n)+φ_{wbf}+P₁(n)+P₂(n),n=0:L−1

The residual echo is therefore:

e(n)=y(n)−φ_{wyf} (n)*xt(n)

The quality of the estimate is independent of the correlation and non-stationarity of the emitted voice signal.

Adaptive or Complementary Block Identification

For fast characterization of the acoustic channel, the value of L must be limited.

In this case, the intercorrelation φ_{wxf} is not truly zero and therefore the term f*φ_{wxf}(n), of a power slightly lower than that of φ_{wxf}(n), cannot be completely ignored.

In order to alleviate this problem, the effect of this term can be cancelled out by adding an adaptive filtering step.

A first estimate of the acoustic channel f is thus obtained, as illustrated in FIG. 3.

The adaptive filtering step ADAPT (adaptive filter h(n) of length P) is driven by the filtered watermarked signal xtf (n)=g⁻¹*xt(n) and controlled by the adaptive estimation error:

$$\begin{matrix}er ( n ) = yf ( n ) - h ( n ) * [ xf ( n ) + w ( n ) ] \\ = f * w ( n ) + \underbrace{v ( n ) * xf ( n ) + bf ( n )}_{ξ ( n )} - h ( n ) * w ( n )\end{matrix}$$

where v(n)=f−h(n) is the deviation vector which represents the estimation error for the channel.

Given the signal at the input to the correlator INTERCOR:

$$\begin{matrix}e ( n ) = er ( n ) + h ( n ) * w ( n ) \\ = f * w ( n ) + ξ ( n )\end{matrix}$$

With the convergence of the adaptive filter h(n), the power of the error ξ(n) converges towards that of the filtered noise bf(n).

The channel estimation occurs by calculating the intercorrelation:

φ_{we}(n)=\hat{f}(n)+φ_{wξ}(n),n=0:L−1

In the case where the filter h(n) converges, the second term of the equation becomes negligible and one obtains a more or less constant estimation quality.

In one variant, block-based filtering can be used. For example, a Wiener filter can be used. As will be apparent to a person skilled in the art, the use of such a filter may require inverting the correlation matrix of the audio signal.

Results

Different voice signals and different acoustic channels have been used to test the method of the invention.

The tests showed that the quality of the received speech is clearly better with the proposed method than when using conventional adaptive methods in which the AEC is driven by the directly received voice signal.

With the method of the invention, the adaptation time is faster and the echo estimation is more stationary.

To obtain comparable results, the performance of the proposed method, in which the adaptive stage is of the NLMS type, has been compared to that of a conventional AEC.

The concerned conventional AEC is an adaptive AEC of the NLMS type. Its input is the input signal x(n) which drives the acoustic channel to be estimated.

The same adaptation pitch μ was used for both AEC (conventional AEC and AEC of the present invention).

The simulation parameters used were the following: L=511, P=200, in the absence of near-end speech.

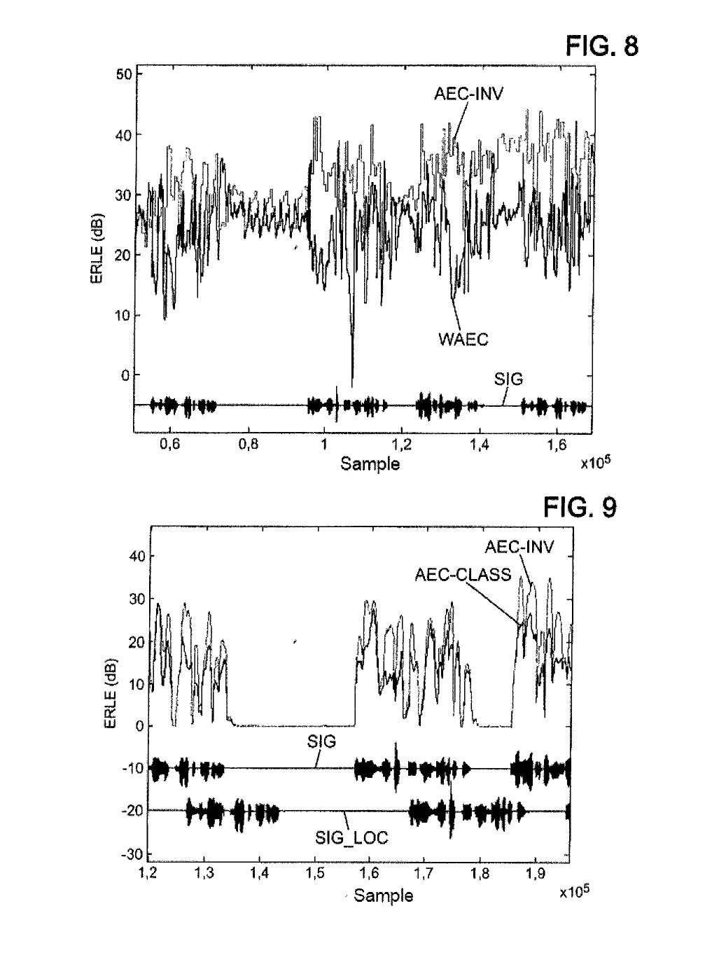

FIG. 6 illustrates the evolution in the root mean square deviation (RMSD), for a method of the invention (AEC_INV curve) and for a method of the prior art (AEC_CLASS curve). The RMSD represents the relative estimation error of f, and is expressed as:

$${RMSD}_{d B} ( n ) = 10 Log [ \frac{E ( {\vert {ϕ}_{we} ( n ) \vert}^{2} )}{{\vert f \vert}^{2}} ] .$$

The RMSD is calculated in the absence of near-end speech and in the presence of ambient noise with a signal-to-noise ratio of 20 dB. The signal-to-noise ratio is expressed as:

$$SNR 1 = 10 Log [ \frac{{P}_{x}}{{P}_{n}} ]$$

where Px is the power of the input signal x(n) and Pn is that of the ambient noise n(n).

As can be seen in FIG. 6, the rate of convergence achieved by the proposed method is clearly superior to that of a conventional AEC.

In addition, the final deviation is lower with the present invention.

The method of the present invention is therefore faster and more precise.

In order to evaluate the steady-state performance of the AEC, the ERLE (echo return loss enhancement) was calculated.

The ERLE is defined by:

$$ERLE = 10 {Log}_{10} [ \frac{E ( {\{ y ( n ) \}}^{2} )}{E ( {\{ e ( n ) \}}^{2} )} ]$$

where y(n) is the noisy echo to be estimated and e(n) is the estimation error.

FIGS. 7 and 8 illustrate, for an initially emitted voice signal SIG which results in an echo signal, the respective evolution in the ERLE for the proposed structure (AEC_INV curve) and for a conventional AEC (for example of the NLMS type, AEC_CLASS curve), in the absence of near-end speech and in the presence of ambient noise and for the proposed structure and for WAEC (WAEC curve), also under the same conditions.

This steady-state comparison shows that the proposed structure guarantees a more stable and higher quality estimation than that offered by a conventional AEC and by WAEC.

FIG. 9 illustrates, for an initially emitted voice signal SIG which results in an echo signal, the evolution of the ERLE in the presence of ambient noise and near-end speech SIG_LOC, in the case of the invention and of a conventional AEC. The power of the near-end speech is generally related to that of the echo by the ratio:

$$SNR 2 = 10 Log [ \frac{{P}_{echo}}{{P}_{s}} ] .$$

In the present case, SNR2=−20 dB. The results show that the proposed structure gives better performance even when near-end speech is present.

The present invention has been described and illustrated in the present detailed description and in the Figures. The invention is not limited to the presented embodiments. Other variants and embodiments may be deduced and implemented by a person skilled in the art upon examining the present description and the attached Figures.

In the claims, the terms “comprise” and “contain” do not exclude other elements or other steps. The indefinite articles “a” or “an” do not exclude the plural. A single processor or several other units may be used to implement the invention. The different features presented and/or claimed may advantageously be combined. Their presence in the description or in different dependent claims does not exclude this possibility. The reference signs are not to be understood as limiting the scope of the invention.

1. A method of cancelling acoustic echo in a first signal comprising an echo signal of a second signal, wherein the method comprises:
inserting in the second signal, in an inaudible manner, a pseudo-random sequence whose circular autocorrelation comprises a unit impulse and a continuous component,
characterizing, in the first signal, by means of the inserted sequence, an acoustic channel followed by the echo signal,
estimating the echo signal in the first signal by means of the characterization of the acoustic channel, and
cancelling the echo signal by means of the obtained estimation.

2. The method according to claim 1, wherein the characterization of the acoustic channel is done by intercorrelation of the first signal with the pseudo-random sequence.

3. The method according to claim 1, wherein the characterization of the acoustic channel comprises at least one from among an adaptive filtering of the second signal and a block-based filtering of the second signal.

4. The method according to claim 1, wherein the characterization of the acoustic channel comprises the steps of:
performing an adaptive and/or block-based filtering of the second signal, and
performing an intercorrelation of the first signal with the pseudo-random sequence.

5. The method according to claim 1, further comprising:
applying a shaping filter to the pseudo-random sequence before it is embedded in the second signal.

6. The method according to claim 3, further comprising a step of processing the first signal before the intercorrelation with the pseudo-random sequence, said processing comprising the subtracting of a result of the filtering of the second signal from the first signal.

7. A computer program comprising instructions for implementing a method according to claim 1 when it is executed by a processor.

8. A circuit configured to implement a method according to claim 1.

9. A system for cancelling echo in a first signal comprising an echo signal of a second signal, said system comprising:
a unit for inserting into the second signal, in an inaudible manner, a pseudo-random sequence whose circular autocorrelation comprises a unit impulse and a continuous component,
a unit for characterizing, in the first signal, by means of the inserted sequence, an acoustic channel followed by the echo signal,
a unit for estimating the echo signal in the first signal by means of the characterization of the acoustic channel, and
a unit for cancelling the echo signal by means of the obtained estimate.

10. The system according to claim 9, wherein the unit for characterizing the acoustic channel comprises a unit for the intercorrelation of the first signal with the pseudo-random sequence.

11. The system according to claim 9, wherein the unit for characterizing the acoustic channel comprises at least one from among an adaptive filter for the second signal, and a block-based filter for the second signal.

12. The system according to claim 9, wherein the unit for characterizing the acoustic channel comprises:
an adaptive and/or block-based filter for the second signal, and
a unit for the intercorrelation of the first signal with the pseudo-random-sequence.

13. The system according to claim 9, further comprising:
a filter for shaping the pseudo-random sequence before it is embedded in the second signal.

14. The system according to claim 11, further comprising a unit for processing the first signal before the intercorrelation with the pseudo-random sequence, said processing comprising the subtracting of a result of the filtering of the second signal from the first signal.

15. The system according to claim 9, further comprising:
a first input for receiving the first signal,
a first output for sending the first signal with the cancelled echo signal,
a second input for receiving the second signal, and
a second output for sending the second signal with the embedded sequence.
